(19) United States
(12) Patent Application Publication
(10) Pub. No.: US 2022/0109508 A1
(43) Pub. Date: Apr. 7, 2022

(54) OPTICAL RECEIVER AND STATION-SIDE DEVICE

(71) Applicant: MITSUBISHI ELECTRIC CORPORATION, Tokyo (JP)

(72) Inventors: Satoshi YOSHIMA, Tokyo (JP); Takanori KAWANAKA, Tokyo (JP)

(73) Assignee: MITSUBISHI ELECTRIC CORPORATION, Tokyo (JP)

(21) Appl. No.: 17/551,527

(22) Filed: Dec. 15, 2021

Related U.S. Application Data
(63) Continuation of application No. PCT/JP2019/031700, filed on Aug. 9, 2019.

(51) Int. Cl. H04B 10/69

(52) U.S. Cl. CPC H04B 10/69

(57) ABSTRACT

An optical receiver includes a transimpedance amplifier that converts a current signal output from a light-receiving element that receives an optical signal into a voltage signal, and has a variable conversion gain when performing the conversion, a gain control circuit that detects the bottom voltage of the voltage signal output from the transimpedance amplifier and controls the conversion gain of the transimpedance amplifier based on a result of the detection, and a signal detection circuit that outputs a signal detection signal indicating a signal detection result of whether or not an optical signal is being received. When the signal detection signal indicates a transition from an optical signal non-reception state to an optical signal reception state, the gain control circuit terminates the control of the conversion gain and holds the value of the conversion gain at a point in time when the control of the conversion gain is terminated.

### CROSS-REFERENCE TO RELATED APPLICATION

This application is a continuation application of International Application PCT/JP2019/031700, filed on Aug. 9, 2019, and designating the U.S., the entire contents of which are incorporated herein by reference.

### BACKGROUND OF THE INVENTION

### 1. Field of the Invention

The disclosure relates to an optical receiver that receives optical signals in a station-side device in an optical communication system, and the station-side device.

### 2. Description of the Related Art

In recent years, a point-to-multipoint access optical communication system called a passive optical network (PON) system that allows a plurality of users to share a single optical fiber has been widely used. A PON system consists of a single optical line terminal (OLT), which is a station-side device, optical network units (ONUs), which are a plurality of subscriber-side terminal devices, an optical star coupler, which is a passive element connecting the OLT and the ONUs, and optical fibers connecting the CLT, the ONUs, and the optical star coupler.

In such a PON system, ONUs are installed in locations at different distances from an OLT. Thus, light reception levels in the OLT of optical signals transmitted by the ONUs vary from received packet to received packet received by the OLT from the ONUs. Therefore, an optical receiver of the OLT is required to have a wide dynamic range characteristic for reproducing packets of different light reception levels with stability and at high speed. Thus, the optical receiver of the OLT includes an automatic gain control (AGC) circuit that rapdly changes the conversion gain of a transimpedance amplifier that converts a photocurrent output from a light-receiving element into a voltage signal to a proper gain according to the light reception level.

The AGC circuit has a time constant from the start of adjustment of the conversion gain with the start of reception of a packet signal to the convergence of the conversion gain. Thus, the OLT optical receiver requires a predetermined time to perform stable data reproduction after the start of reception of a packet signal. Here, the time required for the conversion gain to converge is limited according to the transmission speed of the system. For example, in 1.25-Gbit/s up G-PON systems standardized in ITU-T G.984 series, 2.5-Gbit/s up XG-PON systems standardized in ITU-T G.987 series, and 10-Gbit/s up XGS-PON systems standardized in ITU-T G.9807 series, the conversion gain needs to be converged in some tens of nanoseconds or less, and a high-speed AGC function is required.

Here, each packet signal consists of an overhead field and a data field. The overhead field is a “01” alternating fixed code string, and the data field is a random code string. For the AGC function of the OLT optical receiver, it is an ideal operation to converge at a high speed in the overhead field and hold a fixed gain in the data field. For the AGC function implementing this function, various methods have been proposed. For example, the invention described in Japanese Patent No. 6058140 includes a gain control circuit that controls conversion gain on the basis of the bottom voltage of a voltage signal output from a transimpedance amplifier, and a convergence determination circuit that determines whether the gain control circuit is in a convergent state. When the convergence determination circuit detects a transition to the convergent state, the gain control circuit holds the conversion gain at the time of the transition to the convergent state.

In the invention described in Japanese Patent No. 6058140, when it is detected that the output voltage of an operational amplifier constituting a circuit that detects the bottom voltage of a voltage signal output from the transimpedance amplifier, that is, the cathode-side voltage of a diode connected to an output terminal of the operational amplifier has risen with the convergence of AGC, it is determined that a transition to the convergent state has been made, and the operation of the operational amplifier is stopped, and accordingly, the control of the conversion gain is stopped.

However, depending on operating conditions such as temperature and power supply voltage, and a combination of the output voltage of the transimpedance amplifier and bias voltage, there may be a case where the output voltage of the operational amplifier does not increase even though the gain of the operational amplifier has decreased, and the AGC circuit is operating. In this case, the convergence determination circuit cannot detect a transition to the convergent state. Consequently, when identical digits are consecutively input to the optical receiver in the data field, the AGC circuit unnecessarily operates to change the conversion gain, resulting in the problem of an increased bit error rate.

The disclosure has been made in view of the above, and an object thereof is to provide an optical receiver capable of preventing an unnecessary change of the conversion gain of a transimpedance amplifier after the adjustment of the conversion gain of the transimpedance amplifier has been completed.

### SUMMARY OF THE INVENTION

In order to solve the above-stated problem and achieve the object, an optical receiver according to the disclosure includes a transimpedance amplifier to convert a current signal output from a light-receiving element to receive an optical signal into a voltage signal, the transimpedance amplifier having a variable conversion gain when performing the conversion; a gain control circuit to detect a bottom voltage of the voltage signal output from the transimpedance amplifier and control the conversion gain of the transimpedance amplifier based on a result of the detection; and a signal detect on circuit to output a signal detection signal indicating a signal detection result of whether or not an optical signal is being received, wherein, when the signal detection signal indicates a transition from a non-reception state that is a state in which an optical signal is not being received to a reception state that is a state in which an optical signal is being received, the gain control circuit terminates the control of the conversion gain and holds a value of the conversion gain at a point in time when the control of the conversion gain is terminated.

### BRIEF DESCRIPTION OF THE DRAWINGS

FIG. 1 is a diagram illustrating an example configuration of an optical communication system implemented by applying an optical receiver according to a first embodiment;

FIG. 2 is a diagram illustrating an example configuration of the optical receiver according to the first embodiment;

FIGS. 3A to 3E are timing charts illustrating an example operation of the optical receiver according to the first embodiment;

FIG. 4 is a diagram illustrating an example configuration of an optical receiver according to a second embodiment;

FIGS. 5A to 5F are timing charts illustrating an example operation of the optical receiver according to the second embodiment;

FIG. 6 is a diagram illustrating an example configuration of an optical receiver according to a third embodiment;

FIGS. 7A to 7G are timing charts illustrating a first example operation of the optical receiver according to the third embodiment;

FIGS. 8A to 8G are timing charts illustrating a second example operation of the optical receiver according to the third embodiment; and

FIG. 9 is a diagram illustrating an example configuration of an optical receiver according to a fourth embodiment.

### DETAILED DESCRIPTION OF THE PREFERRED EMBODIMENTS

Hereinafter, an optical receiver and a station-side device according to embodiments of the disclosure will be described in detail with reference to the drawings.

### First Embodiment

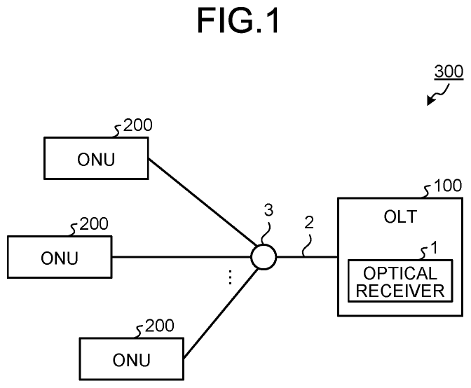

FIG. 1 is a diagram illustrating an example configuration of an optical communication system implemented by applying an optical receiver according to a first embodiment.

An optical communication system 300 according co the present embodiment is a PON system in the form of point-to-multipoint optical communication. As illustrated in FIG. 1, the optical communication system 300 includes a single OLT 100, which is a station-side device, ONUs 200, which are a plurality of subscriber-side terminal devices, and an optical star coupler 3 that passively splits and combines optical signals. The station-side device is also called a master station device, and the subscriber-side terminal devices are also called slave station devices. All the ONUs 200 are connected to the OLT 100 via the optical star coupler 3 and an optical fiber 2. The distances between the ONUs 200 and the OLT 100 are different. In the example configuration of FIG. 1, the single optical star coupler 3 is located between the OLT 100 and the ONUs 200, but two or more optical star couplers 3 may be located between the OLT 100 and some of the ONUs 200 or all of the ONUs 200.

The OLT 100 includes an optical receiver 1. In FIG. 1, the components of the OLT 100 other than the optical receiver 1 are not illustrated.

In the optical communication system 300, upstream communications from the ONUs 200 to the OLT 100 are performed by time-division multiplexing. That is, the OLT 100 allocates times at which data transmission is permitted to the ONUs 200 based on the data amounts of data scheduled to be transmitted by the ONUs 200 or the like, so that the collision of optical signals transmitted by the ONUs 200 is prevented. The ONUs 200 transmit data at the respective allocated times.

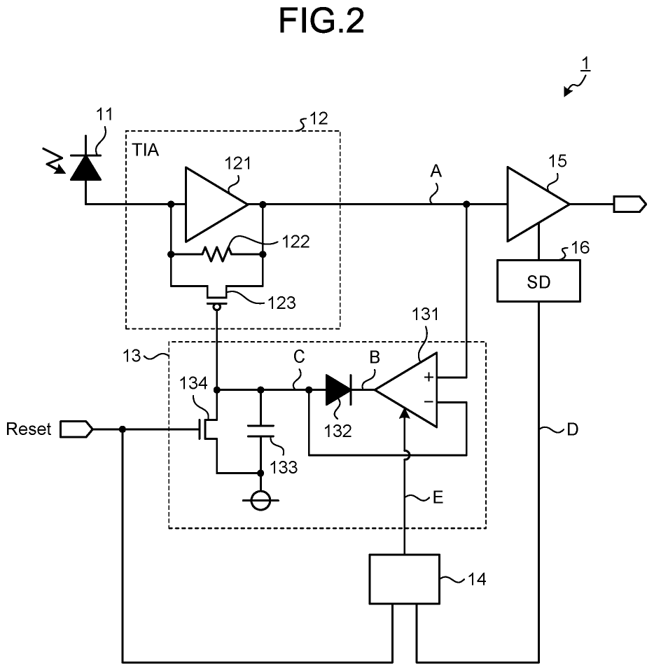

FIG. 2 is a diagram illustrating an example configuration of the optical receiver 1 according to the first embodiment. The optical receiver 1 includes an avalanche photodiode 11, which is a light-receiving element that outputs a current signal corresponding to the intensity of received light, a transimpedance amplifier (TIA) 12 that converts a current signal output from the avalanche photodiode 11 into a voltage signal, a gain control circuit 13 that determines a conversion gain when the transimpedance amplifier 12 converts a current signal into a voltage signal for each received packet, a determination circuit 14 that determines an operation stop of the gain control circuit 13 based on a reset signal (Reset) input from the outside and a signal detection signal to be described later, a downstream amplifier 15 that amplifies a voltage signal output from the transimpedance amplifier 12, and a signal detection (SD) circuit 16 that, generates the signal detection signal based on a signal flowing in the downstream amplifier 15. Although FIG. 2 illustrates the configuration in which the signal detection circuit 16 detects a signal using a signal in the downstream amplifier 15, a signal may be detected using an output signal from the transimpedance amplifier 12, or a signal may be detected using an output signal from the downstream amplifier 15. The signal detection signal is a signal indicating whether or not the optical receiver 1 is in a state of receiving an optical signal, and, for example, becomes a high voltage when the signal deter ton circuit 16 determines that an optical signal is being received.

The transimpedance amplifier 12 includes an operational amplifier 121, a fixed resistor 122, and a variable resistance element 123. In the transimpedance amplifier 12, the resistance values of the fixed resistor 122 and the variable resistance element 123 connected in parallel to the operational amplifier 121 determine the conversion gain in converting a current signal into a voltage signal. The variable resistance element 123 is formed of, for example, a field-effect transistor (FET) or the like, and is a circuit element whose resistance value can be controlled by an input voltage. The variable resistance element 123 receives the input of a gain control signal generated by the gain control circuit 13 based on the bottom voltage of a voltage signal. Thus, the transimpedance amplifier 12 can output a voltage signal subjected to current-to-voltage conversion by the conversion gain controlled on the basis of the bottom voltage.

The gain control circuit 13 includes an operational amplifier 131, a diode 132 with a cathode terminal connected to an output terminal of the operational amplifier 131, a capacitor 133 with one end connected to an anode terminal of the diode 132, and a switch 134 connected in parallel to the capacitor 133. An output terminal of the transimpedance amplifier 12 is connected to a non-inverting input terminal of the operational amplifier 131, and the anode terminal of the diode 132 is connected to an inverting input terminal of the operational amplifier 131. The capacitor 133 is charged by the voltage of the anode terminal of the diode 132. The switch 134 operates according to the state of the reset signal input from the outside (hereinafter referred to as an external reset signal) to release the charge stored in the capacitor 133. Here, the external reset signal is a pulse signal output from any circuit that detects the end of a packet signal. When the end of a packet signal is detected, a pulse signal is input to the switch 134. The external reset signal is a signal indicating that the input of a packet signal has been completed. When the external reset signal is input, that is, when the input of a packet signal is completed, the switch 134 goes into the ON state and releases the charge stored in the capacitor 133.

The signal detection circuit 16 is a circuit that outputs as the signal detection signal a high voltage when a received packet signal is present and a low voltage when no received packet signal is present. For example, when the amplitude of an input signal becomes a predetermined value, the signal deter ion circuit 16 determines that a received packet signal is present. At this time, to prevent erroneous detection, the signal detection circuit 16 may determine that a received packet is present when a state in which the amplitude has become a predetermined value has continued for a certain period of time, or to achieve instantaneous signal detection, the signal detection circuit 16 may determine that a received packet is present when a transition is once made to a state in which the amplitude has become a predetermined value. The signal detection circuit 16 may be a circuit that continues to output a high signal until the reset signal is input even when a received packet signal is no longer present after starting the output of the high voltage. In this case, the optical receiver 1 is configured such that the external reset signal is also input to the signal detection circuit 16. If the relationship between high and low in the output voltage is switched, that is, if the signal detection circuit 16 outputs the low voltage when a received packet signal is present, there is no problem as long as the determination circuit 14 downstream thereof performs operation described later.

The determination circuit 14 starts to output a low voltage on the rising edge of the external reset signal and starts to output a high voltage on the rising edge of the signal detection signal. That is, the determination circuit 14 is a logic circuit that outputs a signal that becomes the high voltage when the signal detection circuit 16 detects a signal and becomes the low voltage when the rising edge of the external reset signal is detected. Here, the low voltage means an operation start signal to the operational amplifier 131, and the high voltage means an operation stop signal to the operational amplifier 131. The signal output from the determination circuit 14 is input to a shutdown terminal of the operational amplifier 131. In the following description, the signal output from the determination circuit 14 is referred to as a convergence determination signal. In a configuration where the signal detection circuit 16 outputs the low voltage when a received packet is present, the determination circuit 14 operates to start to output the high voltage on the falling edge of the signal detection signal.

Based on the convergence determination signal input from the determination circuit 14, in a non-convergent state, that is, when the convergence determination signal has the low voltage, the gain control circuit 13 operates to detect the bottom voltage following an input voltage waveform. On the other hand, in a convergent state, that is, when the convergence determination signal has the high voltage, the gain control circuit 13 stops the operation of following an input voltage waveform, and operates to hold the conversion gain of the transimpedance amplifier 12 at a point in time of a transition from the non-convergent state to the convergent state regardless of the input voltage waveform.

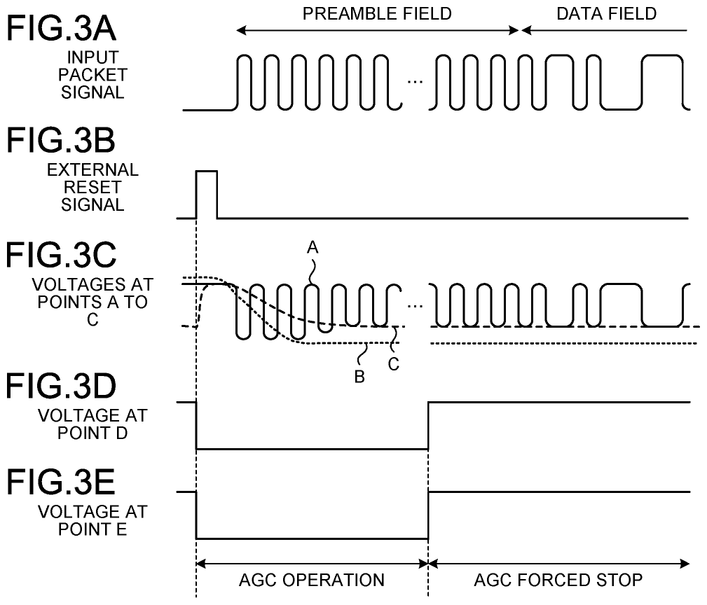

The operation of each part of the optical receiver 1 configured as described above will be described with reference to timing charts in FIGS. 3A to 3E. FIGS. 3A to 3E are timing charts illustrating an example operation of the optical receiver 1 according to the first embodiment. FIG. 3A illustrates an input packet signal to the optical receiver 1, and FIG. 3B illustrates the external reset signal. FIG. 3C illustrates the voltages at points A to C illustrated in FIG. 2. In FIG. 3C, A indicates the voltage at point A, B indicates the voltage at point B, and C indicates the voltage at point C. FIG. 3D illustrates the voltage at point D illustrated in FIG. 2, and FIG. 3E illustrates the voltage at point E illustrated in FIG. 2.

As illustrated in FIG. 3A, a packet signal received by the optical receiver 1 is composed of a preamble field consisting of a “01” alternating fixed code string and a data field consisting of a random pattern including an identical digit consecutive pattern.

Packet signals input from the ONUs 200 to the OLT 100 are transmitted by time division multiplexing so that they do not collide with each other. The external reset signal as illustrated in FIG. 3B is inserted between the packet signals. The external reset signal causes the switch 134 of the gain control circuit 13 to go into the ON state, and the charge stored in the capacitor 133 is released. Consequently, as illustrated in FIG. 3C, the voltage at point C, which is the output voltage of the gain control circuit 13, is initialized to be high, and as a result, the resistance value of the variable resistance element 123 of the transimpedance amplifier 12 is maximized. That is, the optical receiver 1 prepares for a packet signal to be input next in a state where the conversion gain of the transimpedance amplifier 12 is the maximum gain.

When the optical receiver 1 receives the next packet signal, as illustrated in FIG. 3C, at the head of the preamble field, the voltage at point A indicating the voltage output from the transimpedance amplifier 12, which is an inverting amplifier, is a voltage amplified by the maximum gain. That is, the transimpedance amplifier 12 outputs a voltage signal amplified by the maximum gain. At the same time, the voltage output from the gain control circuit 13, that is, the voltage at point C starts to decrease, and the gain control circuit 13 starts an AGC operation so that the voltage becomes equal to the bottom voltage of a voltage waveform at point A.

When the voltage at point C decreases, the resistance value of the variable resistance element 123 decreases, and the conversion gain of the transimpedance amplifier 12 also decreases, so that the amplitude of the voltage waveform at point A transitionally decreases in the operation. When the voltage at point C becomes equal to the bottom voltage at point A, no current flows through the diode 132, and no charge is stored in the capacitor 133 of the gain control circuit 13, so that the voltage at point C does not decrease further.

The anode terminal of the diode 132 is connected to the inverting input terminal of the operational amplifier 131. That is, the voltage at point C is input to the inverting input terminal of the operational amplifier 131. Thus, the voltage at point B indicating the voltage output from the operational amplifier 131 decreases after the reception of the packet signal like the voltage at point C. When the voltage at point C becomes equal to the bottom voltage value at point A, the voltage at point B starts to rise if the operational amplifier 131 operates normally. However, depending on operating conditions such as temperature and power supply voltage, and a combination of the output voltage of the transimpedance amplifier 12 and bias voltage, there may be a case where the voltage at point B does not rise even though the gain of the operational amplifier 131 has decreased, and the voltage at point C has become equal to the bottom voltage value at point A as illustrated in FIG. 3C.

On the other hand, the signal detection circuit 16 determines whether or not a signal is present, based on the amplitude of the output signal from the transimpedance amplifier 12 or the amplitude of the output signal from the transimpedance amplifier 12 after being amplified, and outputs the high voltage when it is determined that a signal is present. For example, when the amplitude of the signal becomes a predetermined value, and that state continues for a predetermined period of time, the signal detection circuit 16 determines that a signal is present and outputs the high voltage. When the signal detection circuit 16 outputs the high voltage in the preamble field as illustrated in FIG. 3D, the determination circuit 14 outputs the high voltage to stop the operation of the operational amplifier 131 as illustrated in FIG. 3E, so that the AGC operation by the gain control circuit 13 can be forcibly stopped.

As described above, the optical receiver 1 according to the present embodiment determines whether a signal of a desired amplitude is present on the basis of a signal output from the transimpedance amplifier 12. When the signal is present, the optical receiver 1 stops the operation of adjusting the conversion gain of the transimpedance amplifier 12 by the gain control circuit 13 so that the transimpedance amplifier 12 continues to use the conversion gain at that point in time. Consequently, even when operation performed under conditions where the output voltage of the operational amplifier 131 of the gain control circuit 13 does not rise even after the control of the conversion gain of the transimpedance amplifier 12 has converged, the operation of the gain control circuit 13 can be stopped. Thus, the conversion gain can be prevented from being unnecessarily changed after the control of the conversion gain of the transimpedance amplifier 12 has converged, and as a result, the bit error rate can be prevented from increasing.

### Second Embodiment

The first embodiment above has described the optical receiver 1 that stops the operation of the gain control circuit 13 when detecting the rising edge of the output signal from the signal detection circuit 16 The following describes an optical receiver that delays the output signal from the signal detection circuit 16 by a proper time to obtain similar effects to the first embodiment even when a signal is detected before the completion of the AGC operation.

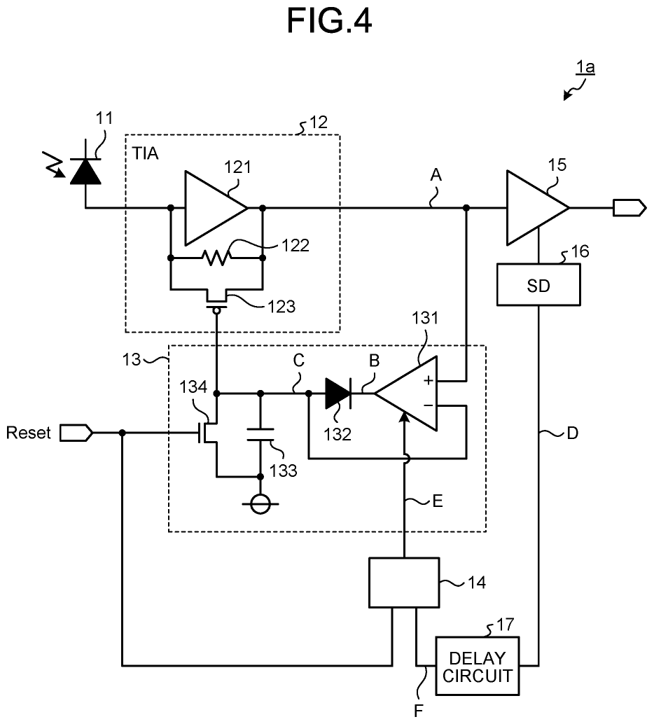

FIG. 4 is a diagram illustrating an example configuration of an optical receiver according to a second embodiment. As illustrated in FIG. 4, an optical receiver 1a according to the second embodiment has a configuration in which a delay circuit 17 is added between the signal detection circuit 16 and the determination circuit 14 of the optical receiver 1 according to the first embodiment illustrated in FIG. 2. Specifically, the optical receiver 1a has a configuration in which the delay circuit 17 is added to the optical receiver 1 described in the first embodiment, and the delay circuit 17 delays the signal detection signal output from the signal detection circuit 16 to delay the timing of input of the signal detection signal to the determination circuit 14. The configuration other than the delay circuit 17 is the same as that of the first embodiment, and thus the configuration other than the delay circuit 17 will not be described.

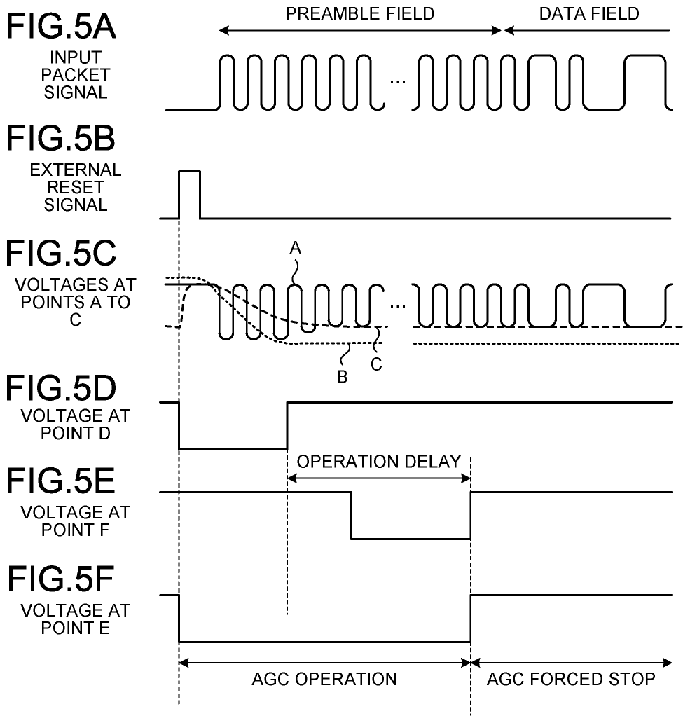

FIGS. 5A to 5F are timing charts illustrating an example operation of the optical receiver 1a according to the second embodiment. FIGS. 5A to 5C illustrate the same signals as FIGS. 3A to 3C. FIG. 5D illustrates the voltage at point D illustrated in FIG. 4, and FIG. 5E illustrates the voltage at point F illustrated in FIG. 4. FIG. 5F illustrates the voltage at point E illustrated in FIG. 4.

Consider a case where, as illustrated in. FIG. 5D, the signal detection circuit 16 outputs the high voltage before the completion of the AGC operation, that is, before the voltage at point C illustrated in FIG. 5C becomes exactly equal to the bottom value of the voltage at point A. In this case, the optical receiver 1 of the first embodiment makes a transition to an AGC forced stop state at a position where the conversion gain of the trans impedance amplifier 12 is not proper.

To avoid this, the delay circuit 17 is added which delays the rising timing and the falling timing of the signal detection signal output from the signal detection circuit 16, so that, as illustrated in FIG. 5E, the rising timing of the voltage at point F can be set to the timing after the operation of the gain control circuit 13, that is, after the control of the conversion gain of the transimpedance amplifier 12 has converged.

The delay circuit 17 can be composed of, for example, an RC filter including a resistor and a capacitor and a buffer circuit connected to an output terminal of the RC filter. Thus, the rising timing and the falling timing of the signal detection signal can be delayed by a period of time during which the rising waveform and the falling waveform of an input signal are rounded by the RC filter. When a desired amount of delay cannot be achieved by a single-stage RC filter and a buffer circuit, such circuits may be connected in multiple stages in cascade to increase the amount of delay to achieve the desired amount of delay. It is also possible to make the amount of delay variable instead of being fixed by preparing a plurality of delay circuits having different amounts of delay in parallel and selecting one of them by a switch or the like.

As described above, the optical receiver 1a according to the present embodiment includes the delay circuit 17 that delays the rising edge and the falling edge of the signal output from the signal detection circuit 16 and inputs the delayed signal to the determination circuit 14. Consequently, the AGC operation by the gain control circuit 13 can be stopped after the control of the conversion gain of the transimpedance amplifier 12 has converged, and the conversion gain of the transimpedance amplifier 12 can be prevented from being fixed at an improper value.

### Third Embodiment

The first embodiment and the second embodiment have described the configuration in which the operation of the gain control circuit 13 is stopped using only the signal detection signal as a trigger. An optical receiver that can obtain similar effects to the first embodiment will be described which uses either the output voltage of the operational amplifier 131 of the gain control circuit 13 or the output voltage of the signal detection circuit 16 as a trigger.

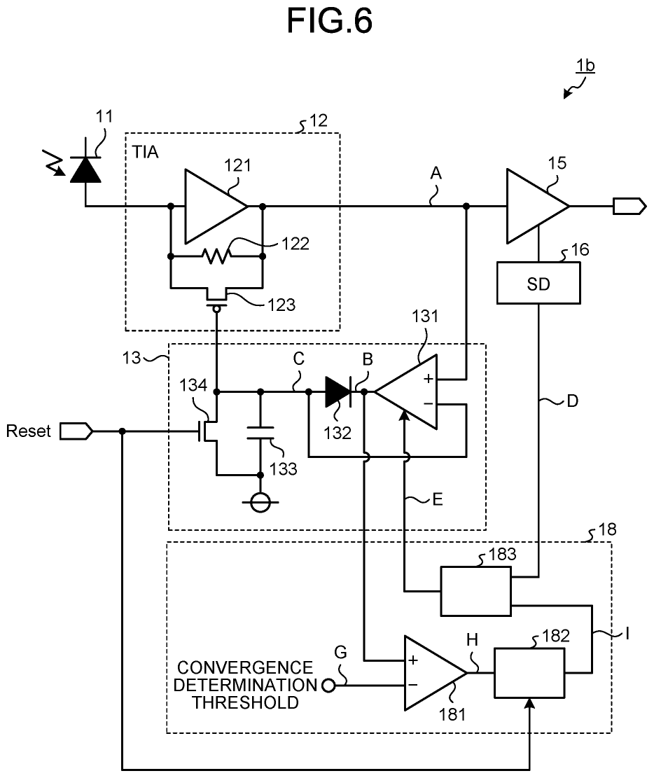

FIG. 6 is a diagram illustrating an example configuration of an optical receiver according to a third embodiment. As illustrated in FIG. 6, an optical receiver 1b according to the third embodiment has a configuration in which a convergence determination circuit 18 is added to the optical receiver 1 according to the first embodiment illustrated in. FIG. 2. The configuration other than the convergence determination circuit 18 is the same as that of the first embodiment, and thus the configuration other than the convergence determination circuit 18 will not be described.

The convergence determination circuit 18 includes a comparator 181 that compares the output voltage of the operational amplifier 131 of the gain control circuit 13 with a convergence determination threshold that is a preset threshold voltage, and outputs a comparison result at a high or low voltage, a logic circuit 182 that generates a convergence determination signal on the basis of an output signal from the comparator 181 and the external reset signal, and a determination circuit 183 that stops the operation of the operational amplifier 131 when detecting the rising edge of the signal output from the signal detection circuit 16 or the rising edge of the signal output from the logic circuit 182.

The logic circuit 182 starts to output a low voltage on the rising edge of the external reset signal and starts to output a high voltage on the rising edge of the output signal from the comparator 181. That is, the logic circuit 182 outputs the signal that becomes the high voltage when the control of the conversion gain by the gain control circuit 13 has converged, and the comparator 181 detects that the output voltage of the operational amplifier 131 has exceeded the threshold voltage with the conversion, and becomes the low voltage when the rising edge of the external reset signal is detected.

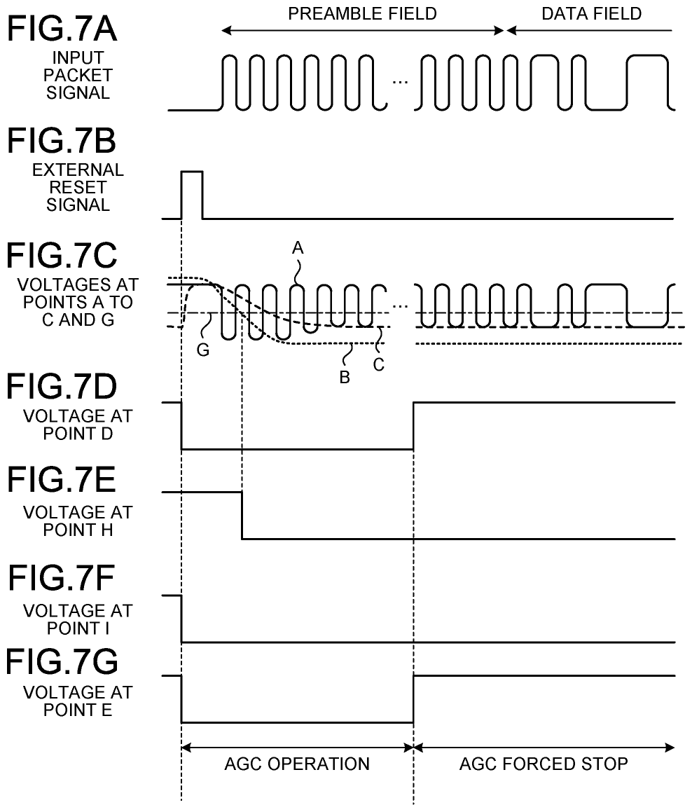

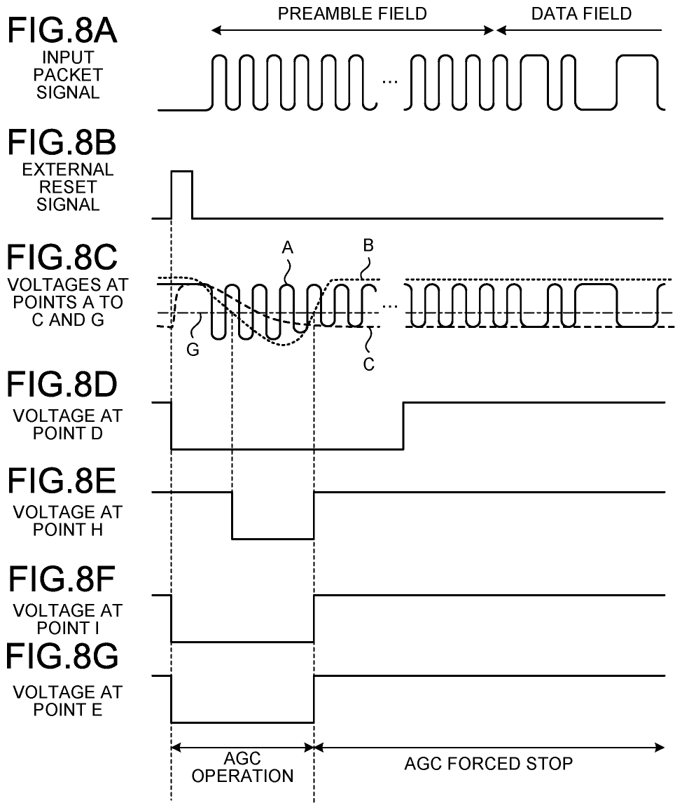

The operation of the optical receiver 1b according to the third embodiment will be described with reference to timing charts in FIGS. 7A to 7G and 8A to 8G. FIGS. 7A to 7G are timing charts illustrating a first example operation of the optical receiver 1b according to the third embodiment, and FIGS. 8A to 8G are timing charts illustrating a second example operation of the optical receiver 1b according to the third embodiment.

First, the first example operation illustrated in FIGS. 7A to 7G will be described. The first example operation is an example operation when the output voltage of the operational amplifier 131 of the gain control circuit 13 does not increase even after the conversion gain of the transimpedance amplifier 12 has converged. FIGS. 7A, 7B, and 7D illustrate the same signals as FIGS. 3A, 3B, and 3D. FIG. 7C illustrates the voltages at points A to C and point G illustrated in FIG. 6. FIG. 7C is obtained by adding the voltage at point G to FIG. 3C, and the voltages at points A to C are the same as those illustrated in FIG. 3C. G indicates the voltage at point G. FIG. 7E illustrates the voltage at point H illustrated in FIG. 6. FIG. 7F illustrating the voltage at point I illustrated in FIG. 6. FIG. 7G illustrates the voltage at point F illustrated in FIG. 6.

As illustrated in. FIGS. 7C and 7E, when the voltage at point B falls below the voltage at point G, the comparator 181 outputs a low signal. That is, the voltage at point H becomes low. In this first example operation, as illustrated in FIGS. 7C, 7E, and 7F, the voltage at point B indicating the output voltage of the operational amplifier 131 of the gain control circuit 13 does not increase after the conversion gain of the transimpedance amplifier 12 has converged. In this case, the voltage at point H does not transition to high after having transitioned to low, so that the voltage at point I that has transitioned to low with the detection of the rising edge of the external reset signal continues to maintain a low state.

On the other hand, as illustrated in FIGS. 7D and 7G, the voltage at point D indicating the state of the signal detection signal output from the signal detection circuit 16 transitions to high when the signal detection circuit 16 detects a signal. As a result, the voltage at point E transitions to high in the preamble field, and the operational amplifier 131 of the gain control circuit 13 stops operating. That is, the optical receiver 1b can forcibly stop the AGC operation by the gain control circuit 13.

Next, the second example operation illustrated in FIGS. 8A to 8G will be described. The second example operation is an example operation when the output voltage of the operational amplifier 131 of the gain control circuit 13 increases normally after the conversion gain of the transimpedance amplifier 12 has converged. FIGS. 8A to 8G illustrate the same signals as FIGS. 7A to 7G.

In FIGS. 8A to 8G, the voltage at point B illustrated in FIG. 8C, that is, the output voltage of the operational amplifier 131 increases after the conversion gain of the transimpedance amplifier 12 has converged in the middle of the preamble. Consequently, as illustrated in FIGS. 8C and 8E, the voltage at point H transitions to low at a timing when the voltage at point B falls below the voltage at point G, and then transitions again to high at a timing when the voltage at point B exceeds the voltage at point G. At this time, as illustrated in FIGS. 8B and 8E to 8G, the voltage at point I transitions to low with the detection of the rising edge of the external reset signal, and then transitions to high at a timing when the voltage at point H that has transitioned to low transitions again to high. As a result, the voltage at point E transitions to high in the preamble field, and the operational amplifier 131 of the gain control circuit 13 stops operating. That is, the optical receiver 1b can forcibly stop the AGC operation by the gain control, circuit 13.

As descried above, the optical receiver 1b according to the present embodiment includes the convergence determination circuit 18 that stops the operation of the operational amplifier 131 of the gain control circuit 13 when the output voltage of the operational amplifier 131 of the gain control circuit 13 rises after the conversion gain of the transimpedance amplifier 12 has converged, or the rising edge of the signal detection signal output from the signal detection circuit 16 is detected. Thus, even when the output voltage of the operational amplifier 131 of the gain control circuit 13 does not increase after the conversion gain of the transimpedance amplifier 12 has converged, the AGC operation by the gain control circuit 13 can be stopped.

### Fourth Embodiment

The third embodiment has described the optical receiver 1b that stops the operation of the operational amplifier 131 of the gain control circuit 13 using the rising edge of the signal detection signal output from the signal detection circuit 16 and the rising edge of the convergence determination signal as a trigger. The present embodiment describes an optical receiver that delays the rising edge of the signal detection signal and stops the operation of the operational amplifier 131 when either the rising edge of the delayed signal detection signal or the rising edge of the convergence determination signal detected.

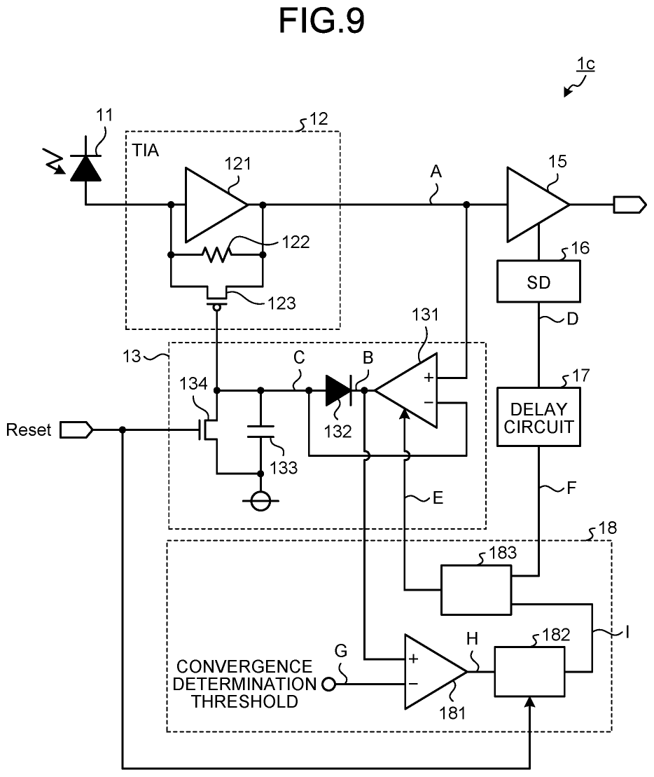

FIG. 9 is a diagram illustrating an example configuration of an optical receiver according to a fourth embodiment. As illustrated in FIG. 9, an optical receiver 1c according to the fourth embodiment has a configuration in which the delay circuit 17 is added between the signal detection circuit 16 and the convergence determination circuit 18 of the optical receiver 1b according to the third embodiment illustrated in FIG. 6. That is, the optical receiver 1c has a configuration in which the delay circuit 17 is added to the optical receiver 1b described in the third embodiment to delay the timing of input of the signal detection signal to the convergence determination circuit 18. The delay circuit 17 is a circuit similar to the delay circuit 17 included in the optical receiver 1a according to the second embodiment.

The operation of the optical receiver 1c is the similar to that of the optical receiver 1b according to the third embodiment except that the delay circuit 17 delays the timing of input of the signal detection signal to the convergence deter enation circuit 18.

In the optical receiver 1c according to the present embodiment, as in the optical receiver 1a according to the second embodiment, a timing at which the voltage at point F rises can be set to the timing after the completion of the operation of adjusting the conversion gain of the transimpedance amplifier 12 by the gain control circuit 13.

The optical receiver according to the disclosure has the effect of being able to prevent an unnecessary change of the conversion gain of the transimpedance amplifier after the adjustment of the conversion gain of the transimpedance amplifier has been completed.

The configurations described in the above embodiments illustrate an example, and can be combined with another known art, and can be partly omitted or changed without departing from the scope.

What is claimed is:

1. An optical receiver comprising:
a transimpedance amplifier to convert a current signal output from a light-receiving element to receive an optical signal into a voltage signal, the transimpedance amplifier having a variable conversion gain when performing the conversion;
a gain control circuit to detect a bottom voltage of the voltage signal output from the transimpedance amplifier and control the conversion gain of the transimpedance amplifier based on a result of the detection; and
a signal detection circuit to output a signal detection signal indicating a signal detection result of whether or not an optical signal is being received, wherein,
the gain control circuit includes an operational amplifier used to detect the bottom voltage,
when the signal detection signal indicates a transition from a non-reception state that is a state in which an optical signal is not being received to a reception state that is a state in which an optical signal is being received, the gain control circuit terminates the control of the conversion gain and holds a value of the conversion gain at a point in time when the control of the conversion gain is terminated, and
the operational amplifier operates based on the voltage signal input when the signal detection signal indicates the non-reception state, and holds an output voltage constant when the signal detection signal indicates the reception state.

2. An optical receiver comprising:
a transimpedance amplifier to convert a current signal output from a light-receiving element co receive an optical signal into a voltage signal, the transimpedance amplifier having a variable conversion gain when performing the conversion;
a gain control circuit to detect a bottom voltage of the voltage signal output from the transimpedance amplifier and control the conversion gain of the transimpedance amplifier based on a result of the detection;
a signal detection circuit to output a signal detection signal indicating a signal detection result of whether or not an optical signal is being received; and
a convergence determination circuit co determine whether the control of the conversion gain by the gain control circuit is in a convergent state or a non-convergent state, wherein,
the gain control circuit includes an operational amplifier used to detect the bottom voltage,
when the signal detection signal indicates a transition from a non-reception state that is a state in which an optical signal is not being received to a reception state that is a state in which an optical signal is being received, or when the convergence determination circuit determines that the control of the conversion gain is in the convergent state, the gain control circuit terminates the control of the conversion gain and holds a value of the conversion gain at a point in time when the control of the conversion gain is terminated, and
the operational amplifier operates based on the voltage signal input when the signal detection signal indicates the non-reception state, and holds an output voltage constant when the signal detection signal indicates the reception state.

3. The optical receiver according to claim 1, wherein
upon input of a reset signal indicating that input of a packet signal is completed, the operational amplifier changes from a state of holding the value of the conversion gain to a state of changing the conversion gain according to intensity of an optical reception signal.

4. The optical receiver according to claim 2, wherein
upon input of a reset signal indicating that input of a packet signal is completed, the operational amplifier changes from a state of holding the value of the conversion gain to a state of changing the conversion gain according to intensity of an optical reception signal.

5. The optical receiver according to claim 1, comprising:
a delay circuit to delay the signal detection signal output from the signal detection circuit.

6. The optical receiver according to claim 2, comprising:
a delay circuit to delay the signal detection signal output from the signal detection circuit.

7. The optical receiver according to claim 3, comprising:
a delay circuit to delay the signal detection signal output from the signal detection circuit.

8. The optical receiver according to claim 4, comprising:
a delay circuit to delay the signal detection signal output from the signal detection circuit.

9. A station-side device comprising the optical receiver according to claim 1.

10. A station-side device comprising the optical receiver according to claim 2.

11. A station-side device comprising the optical receiver according to claim 3.

12. A station-side device comprising the optical receiver according to claim 4.

13. A station-side device comprising the optical receiver according to claim 5.

14. A station-side device comprising the optical receiver according to claim 6.

15. A station-side device comprising the optical receiver according to claim. 7.

16. A station-side device comprising the optical receiver according to claim 6.
